(19) United States
(12) Patent Application Publication
(10) Pub. No.: US 2006/0027247 A1
(43) Pub. Date: Feb. 9, 2006

(54) Transgenic spider silk floss

(76) Inventor: Thomas Studney, River Forest, IL (US)

Correspondence Address: MICHAEL BEST & FRIEDRICH LLC, 401 NORTH MICHIGAN AVENUE, SUITE 1900, CHICAGO, IL, 60611-4212, US

(21) Appl. No.: 11/196,028

(22) Filed: Aug. 3, 2005

Related U.S. Application Data
(60) Provisional application No. 60/599,678, filed on Aug. 6, 2004.

(51) Int. Cl. A61C 15/00

(52) U.S. Cl. 132/321

(57) ABSTRACT

A dental floss includes a filament spun or otherwise created from a protein, such as recombinantly produced spider silk protein. The filament may be coated or surface textured. The filament may also be combined with another like filament or a non-proteinaceous fiber.

### RELATED APPLICATIONS

This application claims priority from U.S. Provisional Application Ser. No. 60/599,678, filed Aug. 6, 2004.

### BACKGROUND

This invention relates to a new material for flossing, comprising at least one biofilament, e.g., transgenic spider silk, and a method of making floss.

### SUMMARY OF THE INVENTION

The dental floss includes a biofilament, which may be coated with a variety of materials and which may be surface textured by a variety of processes. The biofilament may be combined with another biofilament or with a fiber composed of a non-proteinaceous material and not a biofilament, to form a single thread. Preferably, the floss should have elasticity along its longitudinal axis in the range of about 20% to 40% of its length. That is, upon application of suitable tension along the direction of the longitudinal axis of the floss, the floss should be stretchable to extend its at-rest length by about 20% to 40%.

### DETAILED DESCRIPTION

Dental floss has been recommended for many years to remove interdental plaque. Despite this, patient compliance is low, and flossing is not always effective in removing plaque. Persons with small spaces between teeth presently find flossing to be very difficult. If the floss can be inserted at all, the stress caused by attempts to remove plaque causes fraying and breakage, and discourages further attempts to floss. Dental health practitioners and consumers prefer flosses which are gentle to the gums, low in cost per use, resist shredding or fraying and which insert easily between tight teeth, making the floss easier to use. In addition, flavoring agents and other additives are desirable for certain applications. As well, consumers who use various dental floss holders would prefer a floss that could be reused so that the holder need not be rethreaded for each use. And, because dental floss is subject to high abrasion, resulting in rapid wear which can compromise the usefulness of the floss, it is desirable to have a high tenacity fiber with flexural suppleness and high abrasion resistance.

One technology that may be useful for such dental floss applications is biofilament technology, e.g., filaments created (spun) from a protein, including recombinantly produced spider silk protein. Examples of how to manufacture such biofilaments are disclosed in U.S. Published patent application 2004/0102614 A1 (the '614 application), the disclosure of which is incorporated herewith by reference.

Other features of such biofilaments are disclosed in U.S. Published patent application 2001/0042255 A1 (the '255 application), the disclosure of which is incorporated herewith by reference. According to the '255 application, biofilaments have alternating crystalline and amorphous regions. Examples of such naturally occurring biofilaments are spider silk, which is an externally spun fibrous protein secretion found in a variety of arachnids (e.g., Nephila clavipes), and fibroin, an externally spun fibrous protein secretion found in a variety of insects (e.g., Bombyx mori). These biofilaments, when secreted such that the secretion is subjected to shear forces and mechanical extension, have a poly-alanine segment, forming a crystal-forming domain, that undergoes a helix to β-sheet transition, forming a β-crystal that stabilizes its structure. Preferably, the amorphous domain of a biofilament forms a β-pleated sheet such that inter-β-sheet spacings are between 3 angstroms and 8 angstroms in size, preferably, between 3.5 angstroms and 7.5 angstroms in size.

Biofilaments are comparable to the “super-filaments” Spectra™ (commercially available from Honeywell) or Kevlar™ (commercially available from DuPont) in their mechanical strength properties, but surpass them in elongation. Specifically, biofilaments can absorb energy when stretched, and dissipate that energy as heat when the stress is removed. Furthermore, biofilaments are resistant to digestion by proteolytic enzymes, and are insoluble in dilute acids and bases. Indeed, biofilaments are reported to be lighter than Kevlar™ and more flexible than Spectra™.

Biofilaments may be used with a variety of chemical finishes in the processes of spinning, weaving, knitting, and braiding, as well as enhancement of functional properties. They combine low fiber-to-metal frictional properties, good inter-fiber cohesion, and excellent anti-static properties to maximize fiber, filament or yarn performance.

In addition, various lubricants may be added in admixture with the biofilaments. For example, polymer or wax surfactants or finishes may be used, including but not limited to beeswax, microcrystalline wax, mineral oils, fatty acids, for example palmitic acid, methyl ester, isobutyl stearate and/or tallow fatty acid, 2-ethylhexyl ester, polyol carboxyllic acid esters, coconut oil fatty acid esters of glycerol and/or alkoxylated glycerols, silicones, dimethyl polysiloxane, and/or polyalkylene glycols, and ethylene oxide/propylene oxide copolymers, and others known in the art. Bactericides and other products may also be added.

Also, biofilaments may be coated with modifiers to change their permeability to liquids, gases and microorganisms. Modifiers that can be applied to spun spider silk fiber include, but are not limited to, the following: thermally conductive agents (e.g., graphite, boron nitride), ultraviolet-absorbing agents (e.g., benzoxazole, titanium dioxide, zinc oxide, benzophenone and its derivatives), water repellent agents (e.g., alkylsilane, stearic acid salts), therapeutic agents (e.g., antibiotics, hormones, growth factors, antihistamines, analgesics, anesthetics, anxyolytics), stain resistant agents (e.g., mesitol, CB-130), rot resistant agents (e.g., zinc chloride), adhesive agents (e.g., epoxy-resin, neoprene), anti-static agents (e.g., amines, amides, quaternary ammonium salts), biocidal agents (e.g., halogens, antibiotics, phenyl mercuric acetate), blood repellents (e.g., monoaldehyde urea resin), dye and pigments, electrically conductive agents (e.g., metal particles, zinc oxide, stannic oxide, indium oxide, carbon black, silver, nickel), electromagnetic shielding agents (e.g., hypophosphorous, carbon-phenol resin compounds), and flame-retardant agents (e.g., aluminum hydroxide, borax, polyamide, magnesium hydroxide, polypropylene).

Thus, the spun biofilament fibers may possess a diverse range of physical properties and characteristics, depending upon the initial properties of the source materials, i.e., the dope solution, and the coordination and selection of variable aspects of the method practiced to achieve the desired final product, namely, dental floss.

The tensile strength, elasticity, elongation at break, diameter, and cross-sectional characteristics of the biofibers may vary as desired. In addition, the biofibers may be bundled, braided, twisted or spun together with other biofibers or in combination with other fibers, such as various synthetic polymers (e.g., polypropylene, nylon, polyester) or glass fibers, or fibers and silks from other plant and animal sources (e.g., cotton, non-recombinant silk, wool). This allows fibers having different properties to be present in a single filament or piece of dental floss.

Thus, it is believed that a dental floss comprising at least one biofilament would satisfy the need for a floss that is gentle to the gums, low in cost per use, resists shredding or fraying and inserts easily between tight teeth, and is potentially reusable. In addition, the new floss could carry flavoring agents and other additives. Also, the new floss is expected to have high tenacity giving high absolute breaking load relative to other flosses together with flexural suppleness and high abrasion resistance.

The new floss can be made in a variety of dimensions, deniers, tensile strengths, elasticities, elongations at break, and cross-sectional characteristics as desired, depending on those best suited for an individual's teeth. Preferably, the maximum cross-sectional dimension would be in the range of about 0.03 to about 0.22 mm, and the maximum cross-sectional dimension of the floss would be in the range of about 0.2 mm to about 2.0 mm. Additional preferred characteristics of the floss include: ease of passage between teeth, freedom from shredding, easy to hold during use, well able to disrupt and remove dental plaque, and able to be flavored. In addition, the biofibers may be bundled, braided or spun together with other biofibers or in combination with other fibers so as to increase the variety of characteristics available.

The frictional coefficient of the floss could be varied depending on the nature of the patient's teeth. A higher “fuzziness” could be created without the concomitant risk of increased fraying because the fiber's strength is high. This texture could facilitate removal of interdental plaque by grabbing it more readily. Those skilled in the art will be able to manipulate the surface texture of the floss by various methods such as flocking, coating, adhering additives, crimping, scoring, twisting, and braiding.

As previously mentioned, persons with small interstitial spaces between teeth would benefit from a stronger floss of smaller circumference, resulting in reduced breakage and better compliance with flossing. Thus, a person with small interstitial spaces between teeth would be encouraged to use a floss of smaller diameter; and a person with larger spaces, a larger diameter.

The floss could be loaded on a flosser that could be sanitized, either chemically or by other means, and the floss repeatedly reused. One example of a flosser in which this floss could be loaded and used (among others) is the GUM® Eez-Thru® flosser available from Sunstar Butler of Chicago, Ill. The floss could include a color-change agent to indicate that a certain number of uses had been exceeded and that the floss should be replaced. A similar color-change agent could indicate that sufficient fraying had occurred that the floss is no longer effective and should be changed. These agents could be leachable or otherwise responsive to either the sanitization process or the flossing/fraying process. Persons with periodontal disease might be prescribed a floss carrying antibiotics or other treatments that would release slowly as the floss is used and reused.

The foregoing describes a particularly preferred embodiment of the invention. It will be apparent to those skilled in the art that modifications may be made without departing from the spirit and scope of the invention. Accordingly, it is not intended that the invention be limited except as may be necessary in view of the appended claims.

The invention claimed is:

1. A dental floss comprising at least one filament created from a protein.

2. The dental floss of claim 1 wherein the at least one filament has a flavoring agent.

3. The dental floss of claim 1 wherein the at least one filament has a cross-sectional dimension in the range of about 0.03 mm to about 0.22 mm.

4. The dental floss of claim 1 wherein the at least one filament is resistant to digestion by proteolytic enzymes.

5. The dental floss of claim 1 wherein the at least one filament is insoluble in dilute acids and bases.

6. The dental floss of claim 1 wherein the at least one filament has a longitudinal axis and elasticity along the longitudinal axis in the range of about 20% to 40% beyond its at-rest length.

7. The dental floss of claim 1 wherein the at least one filament has a lubricant selected from the group consisting of beeswax, microcrystalline wax, mineral oils, fatty acids, and ethylene oxide/propylene oxide copolymers.

8. The dental floss of claim 1 wherein the at least one filament is coated with a modifier selected from the group consisting of a thermally conductive agent, an ultraviolet-absorbing agent, a water repellent agent, a therapeutic agent, a stain resistant agent, a rot resistant agent, an adhesive agent, an anti-static agent, a biocidal agent, a blood repellent, an electrically conductive agent, an electromagnetic shielding agent, a flame-retardant agent, a dye, and a pigment.

9. The dental floss of claim 1 wherein the at least one filament is combined with a non-proteinaceous fiber into a single thread.

10. The dental floss of claim 9 wherein the at least one filament and non-proteinaceous fiber are combined by a method selected from the group consisting of bundling, braiding, twisting, and spinning.

11. The dental floss of claim 9 wherein the non-proteinaceous fiber is selected from the group consisting of synthetic polymer, glass fiber, plant fiber, animal fiber, plant silk, and animal silk.

12. The dental floss of claim 1 wherein the at least one filament has a surface textured by a method selected from the group consisting of flocking, coating, adhering additives, scoring, crimping, twisting and braiding.

13. The dental floss of claim 1 wherein the at least one filament has a color-change agent to indicate that a certain number of uses had been exceeded.

14. The dental floss of claim 1 wherein the at least one filament has a color-change agent that indicates when sufficient fraying has occurred to discard the floss.

15. The dental floss of claim 1 wherein the at least one filament includes an antibiotic.

16. A dental floss comprising at least one spider silk filament.

17. The dental floss of claim 16 wherein said filament is coated with a lubricant.

18. The dental floss of claim 16 wherein said filament is coated with a flavoring.

19. The dental floss of claim 16 and a fiber combined with the filament into a single thread, the fiber composed of a material other than a biofilament.

20. The dental floss of claim 19 having a cross sectional dimension in the range of about 0.2 mm to about 2.0 mm.
